(19) United States
(12) Patent Application Publication
(10) Pub. No.: US 2016/0070703 A1
(43) Pub. Date: Mar. 10, 2016

(54) DISTANCE BASED ADJUSTMENTS OF SEARCH RANKING

(71) Applicant: Google Inc., Mountain View, CA (US)

(72) Inventors: Neha Arora, San Mateo, CA (US); Bharat Kalyanpur, Freemont, CA (US)

(73) Assignee: Google Inc., Mountain View, CA (US)

(21) Appl. No.: 14/011,200

(22) Filed: Aug. 27, 2013

(51) Int. Cl. G06F 17/30

(52) U.S. Cl. CPC G06F 17/3053

(57) ABSTRACT

Methods, systems, and apparatus, including computer programs encoded on a computer storage medium, for processing local search results. In one aspect, a method includes receiving data specifying a set of documents ranked according to a first order based on search scores; determining a density score that is based on a number of local documents in the set of documents; determining for each local document: a proximity measure based on the geographic location of the user device and a geographic location specified for the local document and a distance factor based on the proximity measure for the local document and the density score for the set of documents; and adjusting, based at least in part on the distance factors of the local documents, a position of at least one of the local documents in the first order.

### BACKGROUND

This specification relates to processing local search results.

The Internet provides access to a wide variety of resources such as video or audio files, web pages for particular subjects, book articles, or news articles. A search system can identify resources in response to a search query that includes one or more search phrases (i.e., one or more words). The search system ranks the resources based on their relevance to the search query and on measures of quality of the resources and provides search results that link to the identified resources. The search results are typically ordered for viewing according to the rank.

Some search systems can obtain or infer a location of a user device from which a search query was received and include local search results that are responsive to the search query. A local search result is a search result that references a local document. A local document, in turn, is a document that has been classified as having local significance to particular locations of user devices. For example, in response to a search query for “coffee shop,” the search system may provide local search results that reference web pages for coffee shops near the location of the user device. Many users in various geographic regions will likely be satisfied with receiving local results for coffee shops in response to the search query “coffee shop” because it is likely that a user submitting the query “coffee shop” is interested in search results for coffee shops that are local to the user's location.

The number of local search results may depend on the query. To illustrate, for the “coffee shop” query, there may be many local search results, as coffee shops are quite common. However, for the query “public pools,” there may be far fewer local search results than for coffee shops, as the number of public pools in a given area is typically less than the number of coffee shops.

### SUMMARY

In general, one innovative aspect of the subject matter described in this specification can be embodied in methods that include the actions of receiving data specifying a set of documents determined to be relevant to a search query received from a user device, each of the documents having a respective search score indicative of the relevance of the document to the query and ranked according to a first order based on the search scores; determining, from the set of documents, a density score that is based on a number of local documents in the set of documents, each of the local documents being a document that is specified as having local significance to a geographic location of a user device; determining for each local document: a proximity measure based on the geographic location of the user device and a geographic location specified for the local document and a distance factor based on the proximity measure for the local document and the density score for the set of documents; and adjusting, based at least in part on the distance factors of the local documents, a position of at least one of the local documents in the first order so that the documents in the set of documents are ranked according to a second order that is different from the first order. Other embodiments of this aspect include corresponding systems, apparatus, and computer programs, configured to perform the actions of the methods, encoded on computer storage devices.

These and other embodiments can each optionally include one or more of the following features. Determining, for each local document, the proximity measure can be determining the proximity measure based on a difference of the geographic location of the user device and a geographic location specified for the local document.

Determining the distance factor based on the proximity measure for the local document and the density score for the set of documents can be determining the distance factor based on an exponentiation of the proximity measure as a base and the density score as an exponent.

Determining, for each local document, the proximity measure based on the geographic location of the user device and a geographic location specified for the local document can be determining, from among the local documents, a closest local document having a geographic location closest to the geographic location of the user device relative to the geographic locations of the other local documents, scaling each of the geographic locations of the local documents by a distance between the geographic location of the closest local document and geographic location of the user device to generate, for each local document, a scaled distance, and determining, for each local document, the proximity measure based on the scaled distance of the local document.

Determining the distance factor based on the proximity measure for the local document and the density score for the set of documents can be determining the distance factor based on an exponentiation of the proximity measure as a base and the density score as an exponent.

Adjusting, based at least in part on the distance factors of the local documents, a position of at least one of the local documents, can be, for each local document, determining a score factor for the local document based on search score of the local document and a search score of threshold document in the set of documents, the score factor indicating the magnitude of the score for the local document relative to the score of the threshold document, and adjusting the search score of the local document based, in part, on the score factor.

Adjusting, based at least in part on the distance factors of the local documents, a position of at least one of the local documents can be determining a locality intent measure that is a measure of local intent of the query and adjusting the search score of the local document based, in part, on the local intent measure.

Adjusting, based at least in part on the distance factors of the local documents, a position of at least one of the local documents, can be, for each local document: determining a score factor for the local document based on search score of the local document and a search score of threshold document in the set of documents, the score factor indicating the magnitude of the score for the local document relative to the score of the threshold document and adjusting the search score of the local document based, in part, on a product of the score factor, the local intent measure, and the distance factor for the local document.

Determining the density score, the distance factors for each local document, and adjusting the position of at least one local document can be done only in response to the query received from the local device is a query that does not include a location phrase and that is determined to indicate an information need having local intent.

Particular embodiments of the subject matter described in this specification can be implemented so as to realize one or more of the following advantages. A data processing apparatus can provide more relevant search results in response to receipt of a single general search query with an implicit local intent by providing local search results when the general search query is determined to be a locally significant search query for a particular user location. Users are provided information that has been determined to be relevant to their location in response to providing a general search query that does not include a location phrase. Furthermore, promotion of search results that reference local documents can be throttled based on the density of local documents. Thus, a user is not inundated with multiple local documents when many corresponding locations are nearby. Conversely, a local document having a relatively distant location may still be significantly promoted in the absence of other local documents.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides local search results.

FIG. 2 is a graph illustrating a fall-off of an adjustment function for local search result document sets based on distance and density.

FIG. 3 is a flow chart of an example process for adjusting a local search result in a set of search results.

FIG. 4A is a graph illustrating a scaled fall-off of an adjustment function for local search result document sets based on a scaled distance and density.

FIG. 4B is a flow chart of an example process for scaling a proximity measure for a local search result.

FIG. 4C is a graph illustrating a capped fall-off of an adjustment function for local search result document sets based on distance and density.

Like reference numbers and designations in the various drawings indicate like elements.

### DETAILED DESCRIPTION

Local search results in a set of search results are adjusted in a ranking of the search results based, in part, on a density of local search result documents in the set of search result documents and a distance of a local search result document that is closest to a location of a user device relative to locations of other local search result documents. The adjustment may result in a local search result document being boosted in the ranked set of document so that the local search result document is readily identified to the user. For example, the boost may ensure that at least one local search result is presented on a first page of search results, or within the top four search results.

The density of local result documents is based on the number of local search result documents in a set of search result documents that are determined to be responsive to a query. The density may be determined from a subset of the top N search result documents, and be in proportion to the number of local search result documents in the set of the top N search result documents. As the density increases, the magnitude of an adjustment of a search score for a local search result document attenuates more quickly per unit increase of the distance between the user device location and locations of the local search result documents. Thus, for a search result document set with a very high local density, a positive adjustment of a local search result document for a location ten miles from the user device will be less that the positive adjustment of another local search result document at the same distance in a search result document set with a very low local density.

In some implementations, the distance fall-off of an adjustment score is based on an adjusted distance for each local search result document. The distance of each local search result document is adjusted, based in part, on the distance of a local search result document with a corresponding location that is closest to the location of the user device relative to locations corresponding to the other local search results. The distance fall-off begins at the distance of the closest local search results. To illustrate, assume for a first set of search results the closest location corresponding to a local search result document is one mile, and for a second set of search results the closest location corresponding to a local search result document is four miles. The distance fall-off for the first set of search results thus begins at one mile, while the distance fall-off for the second set of search results begins at four miles.

These features and additional features are described in more detail below.

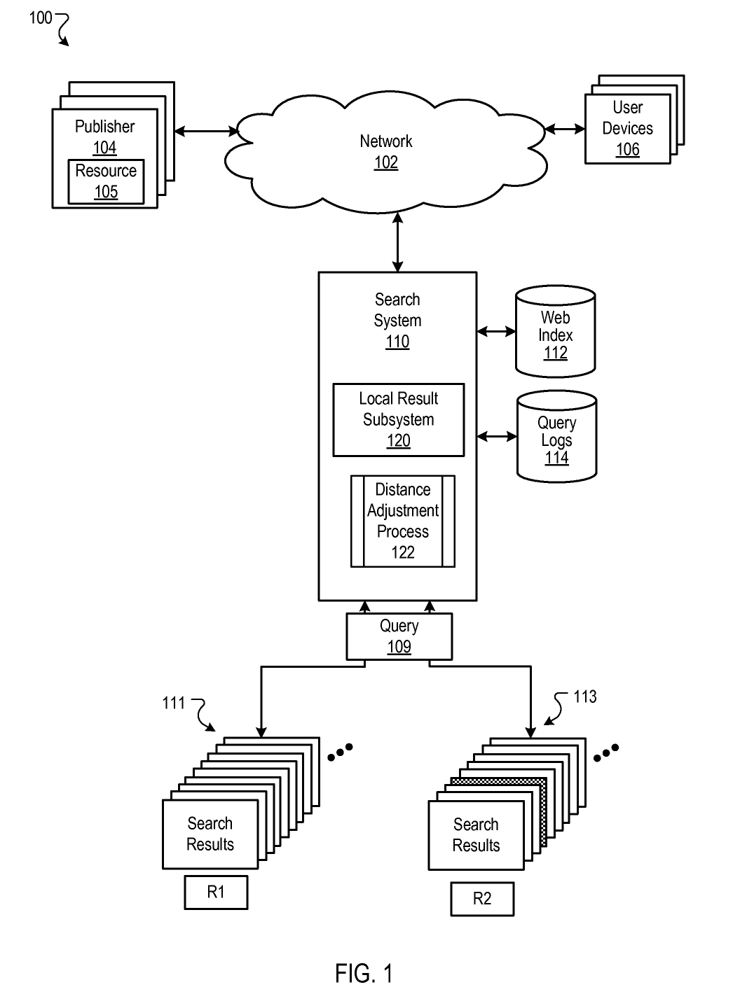

FIG. 1 is a block diagram of an example environment 100 in which a search system 110 provides local search results. The example environment 100 includes a network 102, such as the Internet, and connects publisher websites 104, user devices 106, and the search system 110. Each web site 104 is a collection of one or more resources 105 associated with a domain name and hosted by one or more servers. An example web site is a collection of web pages formatted in hypertext markup language (HTML) that can contain text, images, multimedia content, and programming elements, e.g., scripts. Each web site 104 is maintained by a publisher, e.g., an entity that manages and/or owns the web site.

A resource 105 is any data that can be provided by the web site 104 over the network 102 and that is associated with a resource address. Resources 105 include HTML pages, word processing documents, and portable document format (PDF) documents, images, video, and feed sources, to name just a few. The resources can include content, e.g., words, phrases, images and sounds and may include embedded information (e.g., meta information and hyperlinks) and/or embedded instructions (e.g., scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, e.g., a web browser, to facilitate the sending and receiving of data over the network 102.

To facilitate searching of resources 105, the search system 110 identifies the resources 105 by crawling and indexing the resources 105. Data describing the resources 105 can be indexed and stored in a web index 112.

The user devices 106 submit search queries to the search system 110. In response, the search system 110 accesses the index 112 to identify resources 105 that are determined to be relevant to the search query. The search engine 110 identifies the resources in the form of search results and returns the search results to the user devices 106 in search results page resource. A search result is data generated by the search engine 110 that identifies a resource (generally referred to as a “document”) or provides information that satisfies a particular search query. A search result for a document can include a web page title, a snippet of text extracted from the web page, and a resource locator for the resource, e.g., the URL of a web page. As used in this document, a “search result” is the listing provided in a search results web page, and a “search result document,” or simply “document” is the resource linked to by the search result.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

The user devices 106 receive the search results pages and render the pages for presentation to users. In response to the user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

In some implementations, the queries submitted from user devices 106 are stored in query logs 114. Other information can also be stored in the query logs, such as selection data for the queries and the web pages referenced by the search results and selected by users. The query logs 114 can thus be used to map queries submitted by user devices to resources that were identified in search results and the actions taken by users when presented with the search results in response to the queries.

Although many users may be satisfied with the search results that are generated and presented as described above, the search system 110 can use additional information and utilize additional subsystems to improve the quality of search results for particular users. One example of utilizing additional information is local search result processing. A local result subsystem 120 can identify local documents for a search query. A local document is a document that is specified as having local significance to a geographic location of a user device. A variety of appropriate systems may be used to determine local documents. For example, the local result subsystem 120 may determine a document is a local document if the document includes an address; or if search results for the document have a high rate of selection from user devices in a given location relative to user devices outside of the particular location; or if the local document has been specified by the publisher as being local to a particular location; etc. For queries that have a local intent, the local result subsystem 120 may indicate that certain documents that are determined to be responsive to the query are eligible for promotion. The feature of a document being a local document for certain queries may be stored in the web index 112.

A query may specify a local intent explicitly or implicitly. An explicit specification of local intent occurs when a query includes a location phrase and/or another geographic identifier. A location phrase is one or more terms that specify a geographic location (e.g., a zip code, an address, a city or a state). For example, the search query “Coffee shops Mountain View” includes the location phrase “Mountain View,” such that the search query

“Coffee shops Mountain View” is a local query. For such queries, search result documents that are local to the location specified by the location phrase may be determined to be more relevant than search result documents that are not local to the location. In particular, the location of the user device may be determined to be of little, if any, relevance, as the user has explicitly specified a location.

An implicit specification of locality, however, occurs when user responses to the query indicate a local interest. For example, for the query “coffee shops,” observed user behavior may indicate that search results referencing documents having locations in close proximity to the location of the user device may be selected more often than search results referencing documents having locations that are more distant. Thus, such search queries may be determined to have an implicit local interest with respect to a user's current location. User selection behavior is one example way in which queries can be determined to have an implicit local intent; however, other processes can also be used. The feature of a query having an implicit local intent may be stored in the query logs 114.

When the search system 100 processes a query and identifies documents responsive to the query, the local result subsystem 120, in some implementations, determines if the query has an implicit local intent. If the query does not have an implicit local intent and is not an explicitly local query, e.g., such as the query “quadratic equation,” then the ranking of search result document is not adjusted based on locality. However, if the query does have an implicit local intent, and is not an explicitly local query, e.g., such as the query “coffee shops,” then the local result subsystem 120 performs a distance adjustment process 122.

The distance adjustment process 122, in some implementations, adjusts the search scores of a local document depending on the distance between a location of the user device and a location associated with the local document, and the number of local documents in a given set of document determined to be relevant to the search query. More generally, the adjustment of search score can, in some implementations, be based on the local intent of the query, the distance of the document location from the user device location, the density of local documents, and the distance of the document location of the local document that is determined to be closest to the user device location.

The local intent of the query can, in some implementations, be pre-determined, e.g., by another sub-system, and stored in the query logs. A variety of processes can be used to determine local intent of a query, such as the process that observes user behavior as described above.

In some implementations, the local intent measure of an implicitly local query may be based, in part, on a diversity of local search result documents in a set of documents determined to be responsive to the query. The diversity may be based on, for example, the number of different locations corresponding to the local result documents, or the number of local result documents. The local intent of the query increases as the diversity of local results increases.

The latter factors considered for adjusting a search score—the distance of the document location from the user device location, the density of local documents, and the distance of the document location of the local document that is determined to be closest to the user device location—are used to generate a distance fall-off function value for each local document in a set of search result documents. This distance fall-off value is then used, in part, to calculate a scoring adjustment factor according to the following formula (1):

Adjusted Score Factor=Max_Adj*Dist_Fall_Off*Local_Intent (1)

where:

Max_Adj is a maximum adjustment value;

Dist_Fall_Off is a value on a distance fall off curve for a particular local document; and

Local_Intent is a quantification of the local intent of the query.

The adjusted score factor for a local document can be, for example, combined with the search score of the local document to adjust the position of the local document in the ranking In some implementations, the adjusted score factor can be multiplied with the search score. In other implementations, the adjusted score factor can be added to the search score. Other adjustments to a search score based on the adjusted score factor can also be implemented.

The maximum adjustment value can be selected by human evaluators, or machine learned. In some implementations, the maximum adjustment value can be selected so that any search result document is not boosted more than a maximum percentage relative to its original score. Other constraints for the maximum adjustment value can also be used.

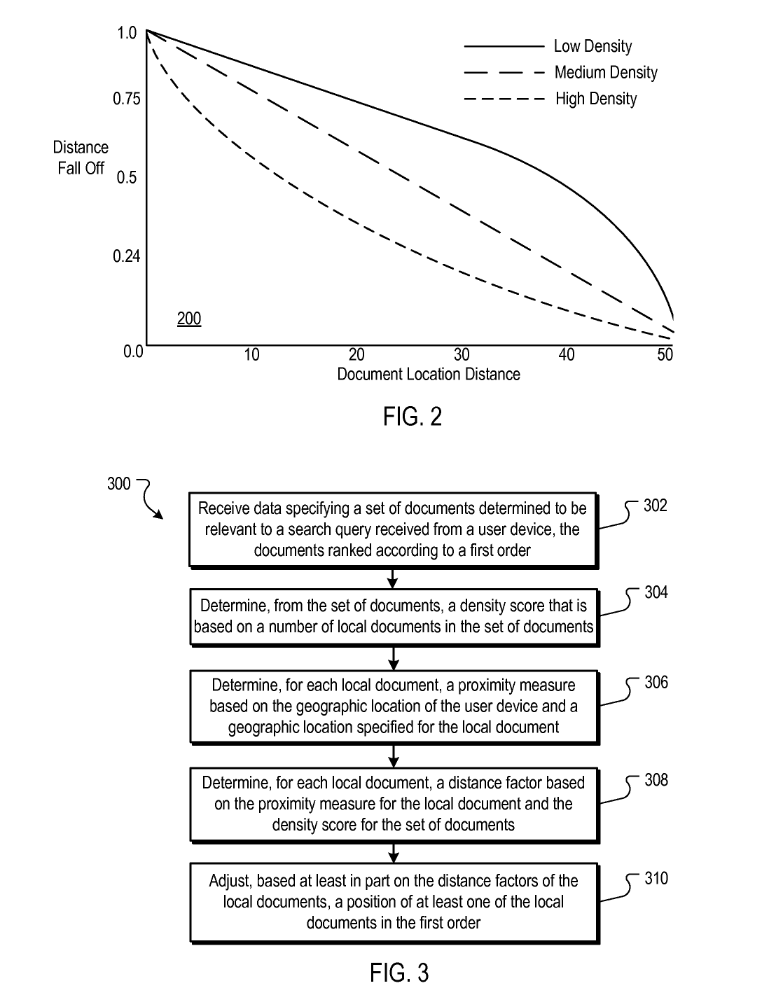

Equation (1) above demonstrates that the distance fall-off function will be determinative of the adjustment of a local document. FIG. 2 is a graph 200 illustrating a fall-off of an adjustment function for local search results based on distance and density. The values along the axes are illustrative and not limiting, and other ranges can also be used, depending on the parameters used.

When the density of the local documents in a set of search result documents is low, i.e., where there are relatively few local documents in the top N documents determined to be responsive to the search query, the distance fall-off tends to decay per unit distance slowly relative to the decay per unit distance for medium and high densities. This is because when there are many local documents such that the density is high, the user's informational need will likely be satisfied by a local document specifying a location close to the user. Accordingly, other documents that are local but more distant need not be boosted upward in the search results rankings However, when there are few local documents such that the density is low, then the user will likely still be interested in a location that is relatively distant.

Each fall-off curve of a particular document set of FIG. 2, in some implementations, is based in part on the following equations for each local document:

DS=f(#LD) (2)

PM=f(UD_LOC, D_LOC) (3)

DF=f(PM, DS) (4)

where:

DS is the density score;

#LD is the number of local documents in a set of result documents D;

PM is a proximity measure;

UD_LOC is a location of the user device;

D_LOC is a location associated with the local document; and

DF is a distance factor value.

In some implementations, the following function can be used for equation (2):

DS=f(#LD)=#LD/Scaling Factor (5)

The number of local documents may, in some implementations, be determined from the first N top-ranked documents. The scaling factor may be a constant, or may vary based on the search scores of the documents, and/or on the size of the set of documents. For example, a scaling factor to measure the local density for the top 100 ranked documents may be different from a scaling factor to measure the local density for the top 200 ranked documents. A variety of scaling factors can be used. The scaling factor can be tuned by human evaluators, or can be machine learned.

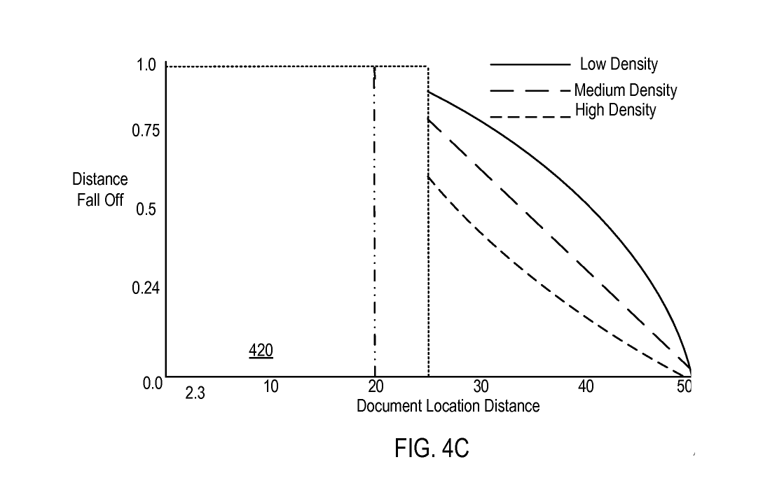

The proximity measure PM can, in some implementations, be based on the geographic location of the user device and a geographic location specified for the local document. For example, the proximity measure can be based on a difference of the geographic location of the user device and a geographic location specified for the local document. In still further implementations, the proximity measure for all local documents can be scaled by a distance between the geographic location of the closest local document and the geographic location of the user device. This scaling is described in more detail with reference to FIGS. 4A and 4B below.

In some implementations, the following function can be used for equation (4) to determine the distance factor:

DF=f(PM, DS)=(1−PM/FOC)̂DS (6)

where FOC is a fall off constant that can be selected by human evaluators or machine learned. In some implementations, the fall off constant is selected so that the value of (1−PM/FOC) is between 0 and 1 and the density score DS is used as an exponent such that the value of DF is between 0 and 1.

In some implementations, the distance factor DF for a local document can be used instead of the distance fall off value to calculate the adjustment, e.g.,

Adjusted Score Factor=Max_Adj*DF*Local_Intent (7)

In other implementations, however a score factor for each local document is also determined and used to adjust the distance factor value. The score factor is based on the search score of the local document and a search score of threshold document in the set of documents. The threshold document may be, for example, the document referenced by a last search result on a first page of search results. For example, if the search system 110 returns search results in sets of 10, then the threshold document is the document that is ranked 10^{th} in the overall set of documents.

The score factor indicates the magnitude of the score for the local document relative to the score of the threshold document. A variety of appropriate magnitude functions can be used, such a logarithmic different functions, relative magnitude functions, etc. In general, if the score for the local document is much lower than the score for the threshold document, then the distance fall off for the local document will increase. This serves to preclude over-promotion of local documents that have a relative low search score when compared to the first set of documents referenced by search results provided to the user. One example equation for using the score factor to adjust distance factor is:

Dist_Fall_Off=DW*DF+(1−DW)*SF (8)

where:

DW is a distance weight; and

SF is the score factor.

The distance weight DW can be selected by human evaluators, or can be machine learned. Selection of the distance weight considers the trade-off of promotion based on distance and penalization based on a relatively low search score.

In operation, the search system 100 performs the calculation described above in response to receiving implicitly local queries that have corresponding local search result documents, and, based on these calculations, may adjust one more local search results.

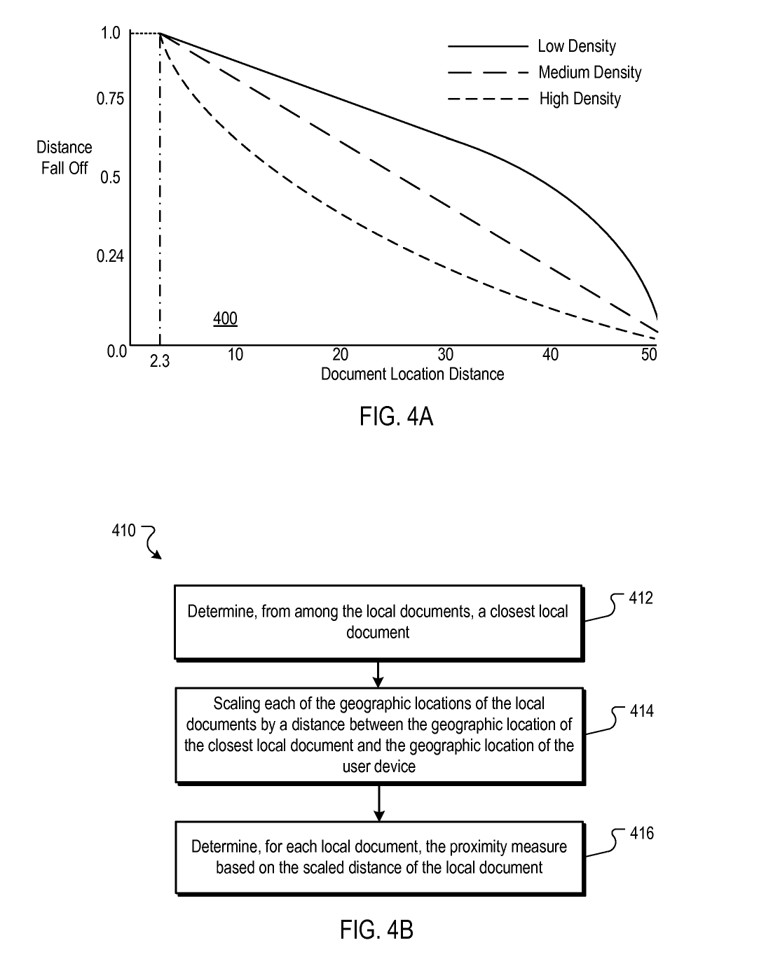

FIG. 3 is a flow chart of an example process 300 for adjusting a local search result in a set of search results. The process 300 can be used in a data processing apparatus used to implement the local result subsystem 120.

The local result subsystem 120 receives data specifying a set of documents determined to be relevant to a search query received from a user device, the documents ranked according to a first order (302). For example, for the query “coffee shops,” the local result subsystem 120 receives the query, data indicating a local intent for the query, and data indicating the top N-ranked documents responsive to the query. The data indicating the local intent for the query can, for example, be provided by another system or process. Each of the documents has a respective search score indicative of the relevance of the document to the query and ranked according to a first order based on the search scores. For example, as shown in FIG. 1, the search results 111 for the documents are ranked according to the order R1.

The local result subsystem 120 determines, from the set of documents, a density score that is based on a number of local documents in the set of documents (304). The density score is based on a number of local documents in the set of documents (e.g. the number of local documents in the top N ranked documents). Each of the local documents is a document that is specified as having local significance to a geographic location of a user device. The documents can, for example, have been specified as being a “local” document, and a corresponding location for each local document stored in the web index 112, by another system or process.

The local result subsystem 120 determines, for each local document, a proximity measure based on the geographic location of the user device and a geographic location specified for the local document (306). The proximity measure is based on the geographic location of the user device and a geographic location specified for the local document. The proximity measure for each local document can be the raw distance determined for that local document, or a value that is proportional to the raw distance. In some implementations, the proximity measure is scaled based on a distance to a closest location from among the locations associated with each local document. FIGS. 4A and 4B below describe this scaling feature.

The local result subsystem 120 determines, for each local document, a distance factor based on the proximity measure for the local document and the density score for the set of documents (308). A variety of appropriate formulas can be used that result in a drop off that increases per unit distance in proportion the density of the local results. For example, the distance factor can be based on an exponentiation of the proximity measure as a base and the density score as an exponent, as described above.

The local result subsystem 120 adjusts, based at least in part on the distance factors of the local documents, a position of at least one of the local documents in the first order (310). In some implementations, the distance factor computed for the local document, in combination with one or more other scores, is used to scale the search score of the local document, such as described with respect to equations (1) and (8) above. As shown in FIG. 1, the search results 113, which each reference an underlying document, have been adjusted according to the order R2. The shaded search result corresponds to a search result referencing a local document and that has been elevated in the ranking based on its adjusted score factor.

As described above, the distance fall-off of an adjustment score can, in some implementations, be based on an adjusted distance for each local search result document. The distance of each local search result document can be adjusted so that the distance fall-off begins at the distance of the closest local search results. To illustrate, assume for a first set of search results the closest location corresponding to a local search result document is one mile, and for a second set of search results the closest location corresponding to a local search result document is four miles. The distance fall-off for the first set of search results thus begins at one mile, while the distance fall-off for the second set of search results begins at four miles.

For example, with reference to FIG. 4A, each set of search results document includes local document that each have an associated geographic location. Assume for each of three sets show the closest geographic location to the user device geographic location is 2.3 miles. Thus, the distance between each location for a local document and the user device is scaled by 2.3 miles (e.g. subtracted) so that the distance fall off curves 400 of FIG. 4B begins at 2.3 miles, and not at 0 miles.

FIG. 4B is a flow chart of an example process for scaling a proximity measure for a local search result. The process 410 can be used in a data processing apparatus used to implement the local result subsystem 120.

The local result subsystem 120 determines, from among the local documents, a closest local document (412). For example, with reference to FIG. 4A, assume that from among the locations associated with the local documents in a set of documents responsive to a query, the closest location to a location of a user device is 2.3 miles.

The local result subsystem scales each of the geographic locations of the local documents by a distance between the geographic location of the closest local document and the geographic location of the user device (414). Continuing with the example in which the closest location to a location of a user device is 2.3 miles, the local result subsystem 120 sales the distance for each local document by 2.3 miles by subtracting the distance of 2.3 miles. The scaling effectively shifts the distance fall off curve by 2.3 miles, as illustrated in FIG. 4A.

The local result subsystem determines, for each local document, the proximity measure based on the scaled distance of the local document (416). The proximity measure is calculated as described above, except that for each local document a scaled proximity measure is used.

In some implementations, the scaling can be capped. For example, a cap of 20 miles may be used. Thus, if the closest local document is 25 miles, its corresponding distance fall off will begin at less than unity. An example of capped fall-off curves 400 for various densities is shown in FIG. 4C. In this example, fall-offs begin at 20 miles, and the first falls for each set of documents with a respective closest local document at 25 miles and with respective densities of low, medium and high are shown.

The examples above are described in the context of promoting local documents based on distance. However, selections of scaling factors can also result in a combination of promotion and demotion of local documents.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving data specifying a set of documents determined to be relevant to a search query received from a user device, each of the documents having a respective search score indicative of the relevance of the document to the query and ranked according to a first order based on the search scores;
determining, from the set of documents, a density score that is proportional to a number of local documents in the set of documents, each of the local documents being a document that is specified as having local significance to a geographic location of a user device;
determining for each local document:
a proximity measure based on the geographic location of the user device and a geographic location specified for the local document; and
a distance factor based on the proximity measure for the local document and the density score for the set of documents, wherein the distance factor is determined such that a magnitude of positive adjustment of a position of a local document in the first order decreases at a given proximity measure in inverse proportion to the density score; and
adjusting, based at least in part on the distance factors of the local documents, a position of at least one of the local documents in the first order so that the documents in the set of documents are ranked according to a second order that is different from the first order.

2. The method of claim 1, wherein determining, for each local document, the proximity measure based on the geographic location of the user device and a geographic location specified for the local document comprises determining the proximity measure based on a difference of the geographic location of the user device and a geographic location specified for the local document.

3. The method of claim 2, wherein determining the distance factor based on the proximity measure for the local document and the density score for the set of documents comprises determining the distance factor based on an exponentiation of the proximity measure as a base and the density score as an exponent.

4. The method of claim 1, wherein determining, for each local document, the proximity measure based on the geographic location of the user device and a geographic location specified for the local document comprises:
determining, from among the local documents, a closest local document having a geographic location closest to the geographic location of the user device relative to the geographic locations of the other local documents;
scaling each of the geographic locations of the local documents by a distance between the geographic location of the closest local document and geographic location of the user device to generate, for each local document, a scaled distance; and
determining, for each local document, the proximity measure based on the scaled distance of the local document.

5. The method of claim 4, wherein determining the distance factor based on the proximity measure for the local document and the density score for the set of documents comprises determining the distance factor based on an exponentiation of the proximity measure as a base and the density score as an exponent.

6. The method of claim 1, wherein adjusting, based at least in part on the distance factors of the local documents, a position of at least one of the local documents, comprises, for each local document:
determining a score factor for the local document based on search score of the local document and a search score of threshold document in the set of documents, the score factor indicating the magnitude of the score for the local document relative to the score of the threshold document; and
adjusting the search score of the local document based, in part, on the score factor.

7. The method of claim 1, wherein adjusting, based at least in part on the distance factors of the local documents, a position of at least one of the local documents, comprises:
determining a locality intent measure that is a measure of local intent of the query; and
adjusting the search score of the local document based, in part, on the local intent measure.

8. The method of claim 7, wherein adjusting, based at least in part on the distance factors of the local documents, a position of at least one of the local documents, comprises, for each local document:
determining a score factor for the local document based on search score of the local document and a search score of threshold document in the set of documents, the score factor indicating the magnitude of the score for the local document relative to the score of the threshold document; and
adjusting the search score of the local document based, in part, on a product of the score factor, the local intent measure, and the distance factor for the local document.

9. The method of claim 1, wherein determining the density score, the distance factors for each local document, and adjusting the position of at least one local document is done only in response to the query received from the local device is a query that does not include a location phrase and that is determined to indicate an information need having local intent.

10. A system, comprising:
a data processing apparatus; and
a data store storing instructions executable by the data processing apparatus and that upon such execution cause the data processing apparatus to perform operations comprising:
receiving data specifying a set of documents determined to be relevant to a search query received from a user device, each of the documents having a respective search score indicative of the relevance of the document to the query and ranked according to a first order based on the search scores;
determining, from the set of documents, a density score that is proportional to a number of local documents in the set of documents, each of the local documents being a document that is specified as having local significance to a geographic location of a user device;
determining for each local document:
a proximity measure based on the geographic location of the user device and a geographic location specified for the local document; and
a distance factor based on the proximity measure for the local document and the density score for the set of documents, wherein the distance factor is determined such that a magnitude of positive adjustment of a position of a local document in the first order decreases at a given proximity measure in inverse proportion to the density score; and
adjusting, based at least in part on the distance factors of the local documents, a position of at least one of the local documents in the first order so that the documents in the set of documents are ranked according to a second order that is different from the first order.

11. The system of claim 10, wherein determining, for each local document, the proximity measure based on the geographic location of the user device and a geographic location specified for the local document comprises determining the proximity measure based on a difference of the geographic location of the user device and a geographic location specified for the local document.

12. The system of claim 11, wherein determining the distance factor based on the proximity measure for the local document and the density score for the set of documents comprises determining the distance factor based on an exponentiation of the proximity measure as a base and the density score as an exponent.

13. The system of claim 10, wherein determining, for each local document, the proximity measure based on the geographic location of the user device and a geographic location specified for the local document comprises:
determining, from among the local documents, a closest local document having a geographic location closest to the geographic location of the user device relative to the geographic locations of the other local documents;
scaling each of the geographic locations of the local documents by a distance between the geographic location of the closest local document and geographic location of the user device to generate, for each local document, a scaled distance; and
determining, for each local document, the proximity measure based on the scaled distance of the local document.

14. The system of claim 13, wherein determining the distance factor based on the proximity measure for the local document and the density score for the set of documents comprises determining the distance factor based on an exponentiation of the proximity measure as a base and the density score as an exponent.

15. The system of claim 10, wherein adjusting, based at least in part on the distance factors of the local documents, a position of at least one of the local documents, comprises, for each local document:
determining a score factor for the local document based on search score of the local document and a search score of threshold document in the set of documents, the score factor indicating the magnitude of the score for the local document relative to the score of the threshold document; and
adjusting the search score of the local document based, in part, on the score factor.

16. The system of claim 10, wherein adjusting, based at least in part on the distance factors of the local documents, a position of at least one of the local documents, comprises:
determining a locality intent measure that is a measure of local intent of the query; and
adjusting the search score of the local document based, in part, on the local intent measure.

17. The system of claim 16, wherein adjusting, based at least in part on the distance factors of the local documents, a position of at least one of the local documents, comprises, for each local document:
determining a score factor for the local document based on search score of the local document and a search score of threshold document in the set of documents, the score factor indicating the magnitude of the score for the local document relative to the score of the threshold document; and
adjusting the search score of the local document based, in part, on a product of the score factor, the local intent measure, and the distance factor for the local document.

18. The system of claim 10, wherein determining the density score, the distance factors for each local document, and adjusting the position of at least one local document is done only in response to the query received from the local device is a query that does not include a location phrase and that is determined to indicate an information need having local intent.

19. A non-transitory data store storing instructions executable by a data processing apparatus and that upon such execution cause the data processing apparatus to perform operations comprising:
receiving data specifying a set of documents determined to be relevant to a search query received from a user device, each of the documents having a respective search score indicative of the relevance of the document to the query and ranked according to a first order based on the search scores;
determining, from the set of documents, a density score that is proportional to a number of local documents in the set of documents, each of the local documents being a document that is specified as having local significance to a geographic location of a user device;
determining for each local document:
a proximity measure based on the geographic location of the user device and a geographic location specified for the local document; and
a distance factor based on the proximity measure for the local document and the density score for the set of documents, wherein the distance factor is determined such that a magnitude of positive adjustment of a position of a local document in the first order decreases at a given proximity measure in inverse proportion to the density score; and
adjusting, based at least in part on the distance factors of the local documents, a position of at least one of the local documents in the first order so that the documents in the set of documents are ranked according to a second order that is different from the first order.
